(19) United States
(12) Patent Application Publication
(10) Pub. No.: US 2026/0296780 A1
(43) Pub. Date: Oct. 1, 2026

(54) INTEGRATED STORAGE SEQUENCING AND DELIVERY SYSTEM AND METHOD OF USE

(71) Applicant: HDS Mercury, Inc., Palo Alto, CA (US)

(72) Inventors: Mitchell Weiss, Carlisle, MA (US); David Maxwell Johnston, Lake Oswego, OR (US)

(21) Appl. No.: 19/551,422

(22) Filed: Feb. 26, 2026

Related U.S. Application Data
(63) Continuation of application No. 18/602,765, filed on Mar. 12, 2024.
(60) Provisional application No. 63/489,972, filed on Mar. 13, 2023.

(51) Int. Cl. B65G 1/04

(52) U.S. Cl. CPC B65G 1/0414

(57) ABSTRACT

A system may include a movable cart configured to carry a plurality of trays. A system may also include an automated mobile robot configured to transport the movable cart. A system may further include a docking interface configured to receive the movable cart and align the movable cart for loading or unloading operations.

This patent claims priority as a divisional-continuation of U.S. utility Ser. No. 18/602,765, filed on Mar. 12, 2024, presently pending, which in turn claimed priority as a non-provisional of U.S. Provisional application 63/489,972, filed on Mar. 13, 2023, presently expired, the contents of which are herein incorporated by reference.

### BACKGROUND OF THE INVENTION

### 1. Field of the Invention

The invention is a device and method for inventory management, including the assembly of orders for shipment.

### 2. Background of the Invention

Preparing orders for delivery is a difficult task. Existing approaches address the process in a piecemeal fashion. Most approaches first undertake item selection and only then assemble or compile complete orders. While this approach is suitable for a small variety of items or small orders, the process becomes unmanageable as the number of items or the amount of orders increases. As a result, prior art systems become complex and unmanageable resulting in ever-increasing system complexity.

In many prior art approaches, goods are moved to stationary picker workstations. The pickers can be either employees or a picking tool. The goods are moved in a variety of ways, and the picker stations select and package individual orders or kits. In another prior art approach, a moveable picker travels throughout the warehouse or facility to select goods and sort them into trays or packages. Each of these approaches has significant downsides and is not scalable. For example, in the first approach, it is often necessary to move all items to retrieve only one low-volume target item. In the second approach, the picker can be forced to travel the same route repeatedly, exceeding many miles of travel per day. In some, even medium-sized facilities, the amount of travel can exceed ten miles, which is time-consuming and tiring.

A need exists in the art for a system that allows for inventory management and order picking, which is scalable and does not rely on prior art approaches. The system can combine picking and compiling operations as close to the storage locations to avoid unnecessary travel. The system should provide flexibility in picking and sorting items rather than forcing time-consuming tasks to occur in one designated area. A need also exists for a method of using and manufacturing the components of the system.

Order fulfillment is a complex process involving the retrieval and selection of items, and delivering the items to the consumer or user of those items. There are many approaches to achieving this process, ranging from the fully manual one-order-at-a-time process to fully automated processes. There are several factors that affect the complexity of the process. These are the variety of items from which to select (the SKUs), the number of items in each order, the rate of order placement, the variety of SKUs per order, the predictability of the orders, and the consolidated order “packaging”.

A simple example is the delivery of parts to a line for a manufacturing operation that produces the same product on a daily basis. The parts for that process are selected from a parts storage area and delivered to the line at regular intervals. The size and frequency of the selection and delivery process can be optimized for the production rate and the available inventory and delivery assets. Thus, the delivery plan and item requirements are known in advance and can be easily and quickly scheduled and completed.

At the other end of the complexity spectrum is an e-commerce system having a hundred thousand (or more) SKUs in inventory and orders arriving at random intervals containing multiple items and SKUs per order. In retail grocery, this is typically 20-50 items per order. Orders may not be delayed and consolidated to achieve efficiencies since orders must be fulfilled within a short period of time from placement.

The following activities must take place in an order fulfillment system:
Receive inbound freight,
Separate freight into consumable components,
Prepare inbound materials for storage,
Convey materials to storage,
Store materials,
Retrieve materials,
Convey materials to “picking” stations,
Pick materials to transport containers,
Convey transport containers to packing stations,
Sort items by order,
Pick sorted/consolidated items to packing container,
Prepare (seal, label) packing container,
Convey packing container to the appropriate outbound station,
Load delivery vehicle,
Deliver.

Historically, individual items were stored on shelves directly, or multiple parts in bins were stored on shelves. When an item was required, a person would look up the location of the desired item, travel to the location, and pick the item off the shelf. If they were retrieving multiple items, they would use a “pick list” and a cart, and retrieve multiple items into the cart. They would then transport the cart of goods to the packaging area, where the goods were prepared for delivery to the customer. This is directly analogous to shopping in a supermarket or retrieving reference materials in a library.

As automation is being deployed, several systems have been developed to solve various aspects of the fulfillment process. These systems tend to provide “point” solutions to the overall system. For example, the last few years have seen an explosion in the availability of “item picking” robots that can reach into a bin and remove an individual item. There are sorting systems that sort the items into compartments for packaging. There are mobile robots that reduce the distance traveled by individuals in the warehouses. There are “goods-to-man” systems that move racks of stored materials to human or robot pickers that retrieve the parts and then send them to sorting for packaging or that sort and pack directly.

The embodiment of the order fulfillment system makes use of a new type of storage/retrieval system that integrates storage, retrieval, sequencing, kitting, loading/unloading, and delivery into a single integrated technology. The storage/retrieval system has many unique and novel design elements, as does the delivery and transport system. This specification describes the integrated storage system and its operation with transport carts. It also describes many of the unique design elements of the storage system.

The objective is to do this with fewer steps and handoffs.

### SUMMARY OF INVENTION

An object of the invention is to provide a system that provides a single solution for delivering complete orders. A feature of the invention is that it includes components for storage, retrieval, transport, picking, and order assembly in a single solution. An advantage of the invention is that it provides a system capable of delivering high volume and high mix orders having a large variety of items.

A further object of the invention is to provide a complete product management system. Features of the system include standardized storage, transport, and delivery containers (trays in one embodiment) along with an expandable storage/retrieval system with an item-picking solution and a transport system that is conveyor-less. Advantages of the system are that it provides a complete end-to-end goods point-of-use system.

A yet further object is to provide a system for efficient kitting. A feature of one embodiment of the invention is that it integrates storage, picking, and kitting operations with storage operations. An advantage of the system is that it does not rely on stand-alone approaches, which create repeated work and inefficiencies.

A further object of the invention is to provide an inventory management system that is scalable. A feature of one embodiment of the invention is that it does not require processing of inventory at specific locations and does not rely on fixed conveyors. In one embodiment, the system uses carefully designed storage, determining the length of, and number of, aisles required. Since the aisles are so narrow, and extra compilation tools are not required the storage is optimized for the solution. A benefit of the system is that traffic blockages do not occur, and the system is scalable, in one embodiment.

Another object of the invention is to provide an inventory management system. A feature of this system is that it provides a warehouse execution system (WES) with advanced controls, image processing and can be deployed rapidly. An advantage of the invention is that it provides a turnkey solution with multiple inventory and order processing controls.

### BRIEF DESCRIPTION OF THE DRAWINGS

The invention, together with the above and other objects and advantages, will be best understood from the following detailed description of the preferred embodiment of the invention shown in the accompanying drawings.

FIG. 1 depicts an overview of one embodiment of the invention.

FIG. 2 depicts a tray used in an embodiment of the invention.

FIG. 3 depicts a racking section used in an embodiment of the invention.

FIG. 4 depicts multiple trays used in an embodiment of the invention.

FIG. 5 depicts a rack and shelving assembly used in an embodiment of the invention.

FIG. 6 depicts a rack module used in an embodiment of the invention.

FIG. 7 depicts a tower robot integration with racking used in an embodiment of the invention.

FIG. 8 depicts a tray extractor used in an embodiment of the invention.

FIG. 9 depicts an extractor mounted on a tower used in an embodiment of the invention.

FIG. 10 depicts an example of racking with carts in a dock, used in an embodiment of the invention.

FIG. 11 depicts a cart dock and automated carts used in an embodiment of the invention.

FIGS. 12A-I depict some sample tasks undertaken by the system in one embodiment.

### DETAILED DESCRIPTION OF THE INVENTION

The previous summary and the following detailed description of specific embodiments of the present invention will be better understood when read in conjunction with the appended drawings.

As used herein, an element or step recited in the singular and proceeded with the word “a” or “an” should be understood as not excluding plural said elements or steps unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

This application refers to a “kit” or “kitting.” Kitting refers to the steps of compiling several components into a single payload. A set of parts to be used in assembly of a flat-pack desk comprises such a kit. Items delivered to a single customer are considered a kit, such as an order placed with a grocery store. Components from a warehouse that will be used in a workstation (referred to as a cell) in a process operation are a kit. Another example of a kit is a retail store replenishment order.

The system, in one embodiment, supports a variety of storage types, which can be changed on demand. The types of storage supported are categorized into several types, but the list is not considered exhaustive and storage types can be mixed. One type of storage is Bulk Storage which is high density tray storage, full random access, and usually is stationary. Another type of storage is Cached Storage which are transportable Mini-racks docked in storage system or at work cells. In one embodiment, storage is handled by Tower Robots, which are lightweight, high-performance robots for tray retrieval and storage. Transport is handled by mobile robots that support acquiring, positioning, and transporting Mini-racks. The system, in one embodiment, includes Storage Racks, Mobile Racks, Robot Towers, Transport Robots, and other processing equipment.

### Overview of System

In one embodiment, the system and method described herein can be used with a number of applications, including order fulfillment (business-to-consumer e-commerce or business-to-business supply chain, as examples), line side delivery, for example, in lean or just-in-time manufacturing, sequencing of pre-kitted supplies to consumers, kitting for custom manufacturing, or supply and replenishment such as for retail or distribution.

In one embodiment, the system uses common controls for a number of the system functions; for example, the system relies on Linux PCs for some elements and a standards-compliant messaging system. The system can be deployed in modules which incorporate wiring, safety, and environmental controls. In most embodiments, the system reuses common motors, cameras, and software to improve interoperability and facilitates the replacement of parts. As will be described below, the system relies on standard trays in one embodiment.

As can be appreciated from the description, one embodiment integrates storage, retrieval, kitting, and sorting into a single system.

The key system components, in one embodiment, include a Transport System (Mobile Racks and AMRs), Tray Storage System, Vision Systems, Pick & Pack Stations, Integrated WES System, and an Induction (Receiving) Station.

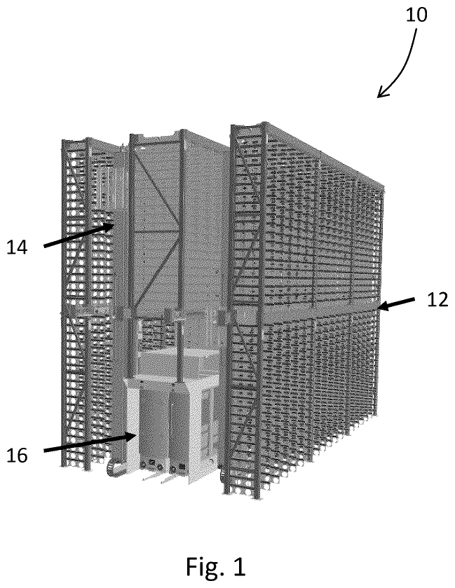

Turning to the figures, FIG. 1 depicts an overview of an embodiment 10, the Integrated Storage, Sequencing, and Delivery System (ISSD). The embodiment 10 is a “tray-based” storage and retrieval system with a high-performance tower system and an integrated interface to transport carts that also act as small storage buffers. Trays are statically stored in a rack 12, or shelving.

Parts (SKUs) are inserted into trays that are designed to fit in the ISSDs. Part loading into the trays may be done automatically or manually. The trays are approximately 390 mm wide, 600 mm long and 125 or 275 mm high. Trays are presented to the ISSDs either on an input port or conveyor, or in one embodiment, by positioning a buffer cart 16 at a load port. The buffer cart 16 has the trays arranged on a shelving system that has the same pitch (space between shelves) as the rack system so that they can be directly unloaded by the storage retrieval robot (a tower robot 14 in one embodiment) and loaded into the fixed rack storage locations.

The benefit of an embodiment of this system is that bulk loads of trays into the system can be made by simply docking the cart to the ISSDs. Parts to be retrieved can be selected as trays and loaded into a single cart, depending on the required part mix. In this way, the trays/parts are ordered/sequenced so that they can be used at the destination as a batched quantity. So, if an order requires ten different SKUs, all the SKUs can be delivered to the destination station in one batch without requiring intermediate sorting and routing steps.

In one embodiment, the storage system consists of a racking frame, shelving, horizontal tower guides, the tower robot, two vertical carriages that travel up and down the tower, two tray extractors on each carriage, the cart interface, and the control system. The following sections will describe these elements of the storage system.

### Tray

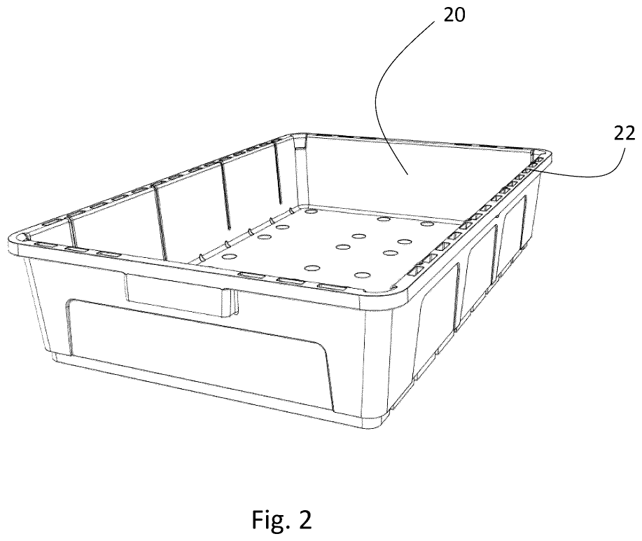

One embodiment of a tray 20 used with the system is shown in FIG. 2. The system is designed to use a standardized tray 20 in which to store inventory or materials. By using trays, the interface between the trays, the racking, and the automation equipment is greatly simplified. Traditional storage systems store trays, or boxes, or bins on shelves. The shelves must be designed to support the maximum anticipated payload across the span of the shelf. This results in the shelf, or its supports, needing to be of sufficient height and strength to reduce sagging, or deflection, of the shelf. Shelves also must be spaced as far apart as is required for the highest object that will fit on the shelf, along with some vertical clearance for reliable operation. If placed on shelves, the parts must be spaced apart horizontally to allow extractor arms to be inserted between the parts to pull them off the shelves.

The system in the presented embodiments, combines the design of the shelving system with the tray 20 to reduce the clearances required around parts, and to eliminate the need for matching shelf height to part height. The operation of this is described as follows.

The trays are of standardized width, length, and height. In one embodiment, the trays 20 are 390 mm wide, 600 mm long, and 125 mm high. The trays have a robust flange 22 around the upper edge that is capable of supporting the fully loaded weight of the tray, even as the tray is manipulated or extended from its storage compartment.

### Rack System

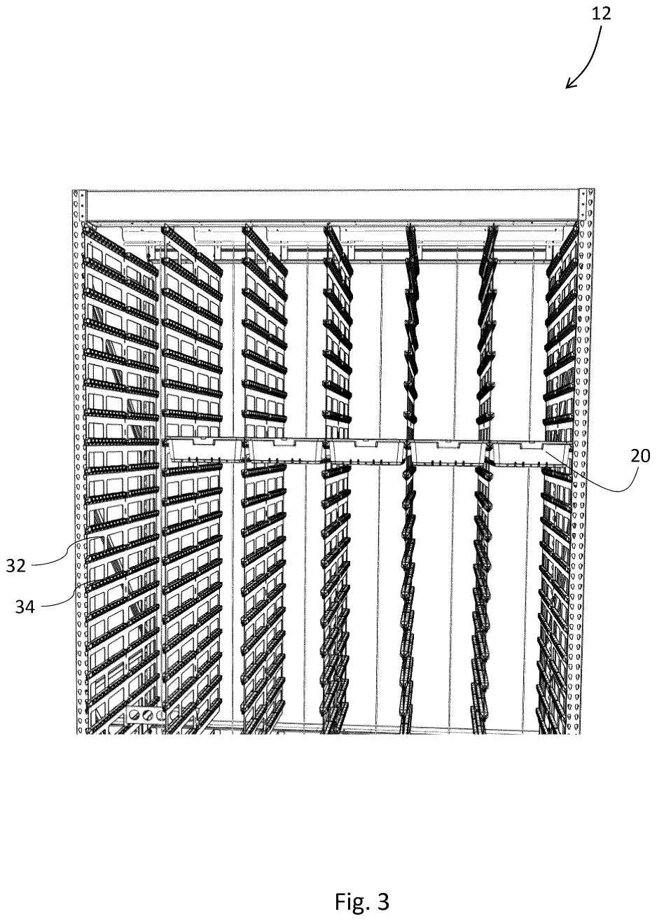

As shown in FIG. 3, the racking system 12 consists of thin metal sheets which are suspended from a pair of overhead support rails. In one embodiment, these are referred to as “shelf risers”. Attached to the faces of the shelf risers 32 are shelf brackets 34 spaced vertically apart in a regular pattern. In one embodiment, they are 150 mm apart. This allows 125 mm high trays to be slotted in at 150 mm vertical intervals with only 25 mm vertical clearance between trays 20, which is less than the typical shelf thickness. However, this 25 mm vertical clearance is enough to allow the insertion of a tray manipulator (extractor). Additionally, the shelf risers 32 are only 1.6 mm thick (since they are in tension, not compression), allowing very dense horizontal packing. FIG. 3 illustrates a section of the racking with a number of trays 20 in position.

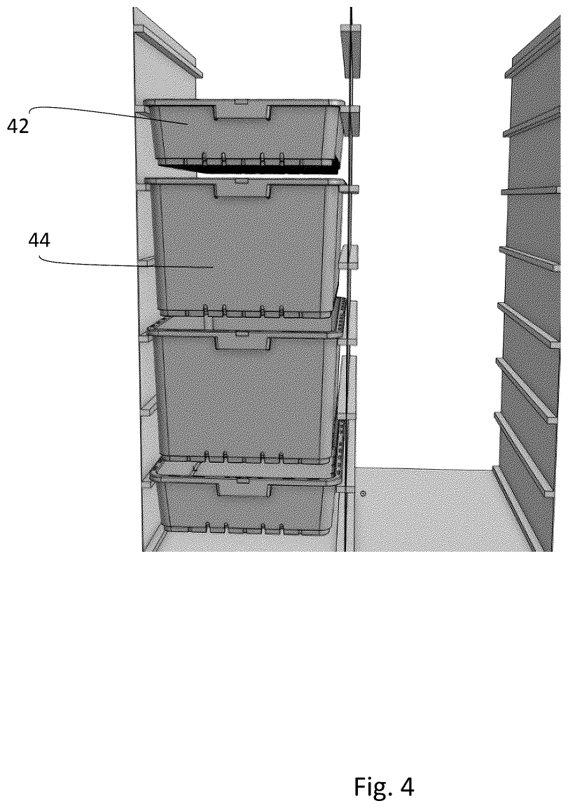

As can be seen in the FIG. 3, the trays 20 can be stored with maximum density. Another feature of the design is that trays of different heights can be stored in any position in the racking (slot) as long as there is not another tray occupying the slot, so that trays of double or triple the height can be stored in the same system with only minimal clearance between trays. This is possible because the tray flange is wider than the tray body, and the shelf brackets are just wide enough to capture the flange. This way, taller trays can hang down into multiple slots. A further example of an embodiment of the use of trays 20 is illustrated in FIG. 4 which provides a simplified view with 125 mm high trays 42 and 275 mm high trays 44. It is notable that the vertical spacing between the trays is the same, because the height of the tray is designed according to: Tray height=(shelf_pitch*n)−25 mm, where n is an integer.

In some embodiments, but not shown in the figures, trays use “compartments” that are fitted into the trays to allow for the storage of multiple SKUs in an organized fashion.

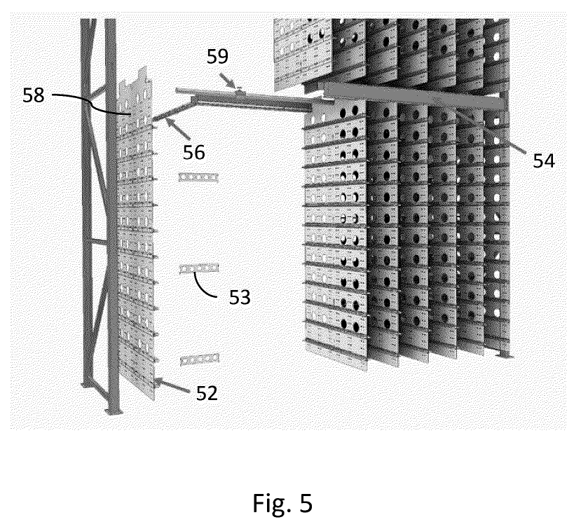

FIG. 5 shows additional details of the racking system 12 for shelves 56 to receive the trays described herein, in one embodiment. As described in the previous section, the racking system 12 is designed to achieve maximum storage density while allowing for tray slotting flexibility. To accomplish this, vertical risers 58 in tension are used to support the shelf 56 brackets, which include spacers 53. These risers must be hung from a rigid system capable of carrying the full weight of the loaded trays.

Standard off-the-shelf racking uprights and cross beams are used to construct the framework of the shelving system. The shelf risers 52 are bolted to the backsides of the crossbeams 54 at the top of the risers, and the risers hang from the cross beams. Details of one embodiment of this construction is seen in FIG. 5.

In some embodiments, commercial off the shelf components (COTS) are used for some parts of the racking system. The use of COTS components for the framework, and thin sheet metal for the risers results in a very cost-effective high-density storage system. In this embodiment, the shelves are injected molded plastic parts, which are very inexpensive to produce. The racks are produced as modules twenty feet tall and eight feet long, in one embodiment. These modules are shipped to the site fully assembled, and then attached along the length to create a full rack up to eighty feet long.

In at least some embodiments, it should be noted that the area between the crossbeams provides an excellent location for fire suppression systems, for example, the sprinklers 59 shown in FIG. 5, as required. The crossbeams are also adapted for distributing power and signal cables, in some embodiments.

Traditional automated storage and retrieval systems (AS/RS) employ a picker crane, or tower, that runs along the facility floor and is supported at the top of the racking. This requires a wear surface or rail to be mounted to the floor, and to be leveled precisely. The taller the crane, the more susceptible the system is to inaccuracy at the top of the tower. Since travel along the length of the aisle occurs at high speeds, the bearings at the bottom of the tower must be spaced far apart to minimize tipping of the tower during acceleration and deceleration.

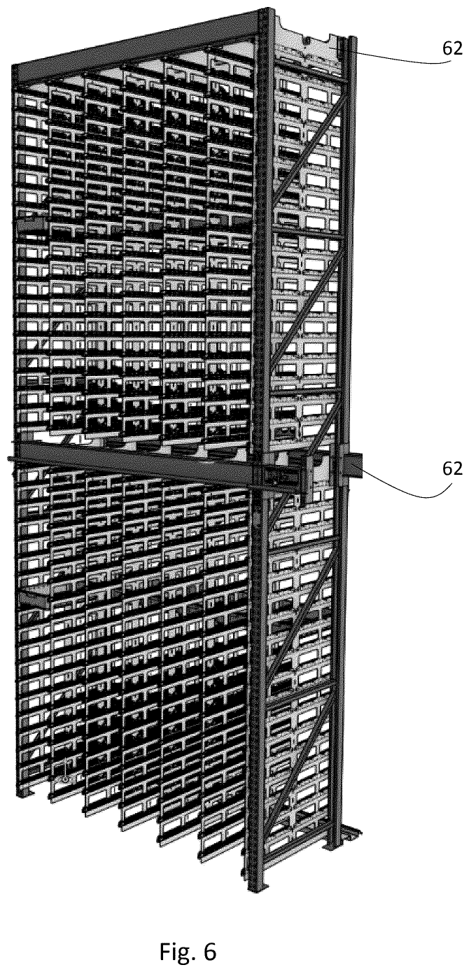

Contrary to these prior art approaches, the system design takes advantage of the horizontal cross beams located at the halfway point up the height of the rack. FIG. 6 shows an eight-foot segment of the rack with the crossbeams 62 at ten feet high and twenty feet high.

Because the racking is assembled in a factory and not built on-site, the precision of the assembly is higher than in prior art approaches. The center crossbeam is modified to provide a support channel for a horizontal drive system. This allows to design a tower crane that is supported at the middle of its height, reducing the unsupported length of the tower by a factor of two, reducing the swaying of the tower at the top and bottom by a factor of 8(2\hat{ }3) over a traditional bottom supported tower. As shown in this embodiment, the drive system is middle-mounted. Also, this embodiment eliminates the need to install the rail to the floor and align the racks with the rail.

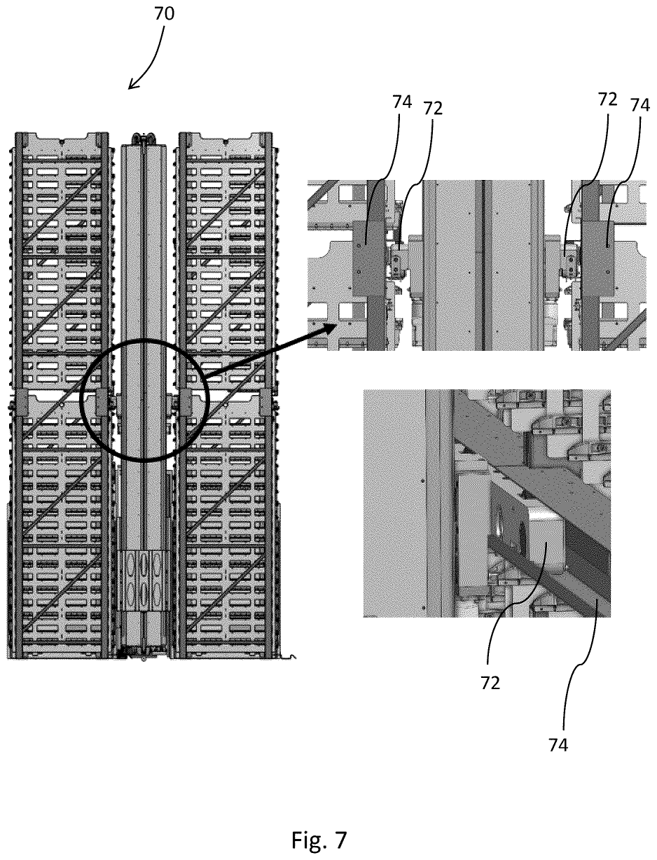

FIG. 7 illustrates the tower 70 and the horizontal drivers 72 “riding” in the channel of the center rail. The tower is supported by both racks to provide vertical precision in two axes. FIG. 7 includes three views of the tower horizontal drive system: an end-on view of a dual rack single aisle system with the tower, a close-up view of the two mid-tower carriages riding along the crossbeams 74, and a perspective view of one of the horizontal drive carriages in the channel attached to the crossbeam 74. In the embodiment show, the carriages act as elevator carriages.

The tower is outfitted with two independently operated vertical carriages. Each carriage includes two tray extractors. This allows the system to store or retrieve four trays on a single “trip” or to swap two trays in and two trays out per trip. Since each carriage and each extractor is operated independently, other activity combinations are possible, including very efficient re-slotting.

### Extractors and Operation

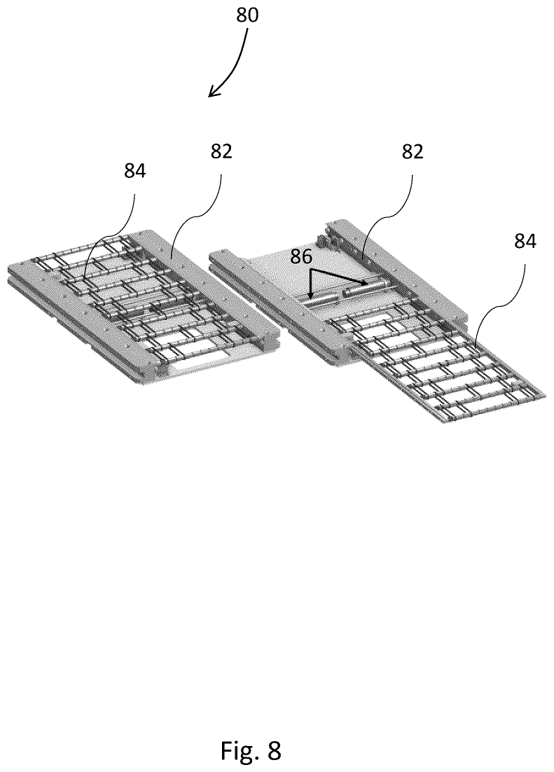

The details of the extractors 80 of one embodiment are shown in FIG. 8. The extractors 80 have a number of key requirements. Preferably, they are able to operate on either side of the aisle. They need to be able to handle fully loaded trays, even at full extension. They need to collapse to a footprint no larger than a tray so that the ISSDs aisles can be as narrow as possible (which is one tray length). Telescoping mechanisms are difficult and expensive to manufacture, especially for bi-directional operation.

The ISSDs extractor 80 is a combination of a powered roller/belt conveyor 82 and a linear extension 84. This embodiment of an extractor is considered a dual-mode extractor as it includes both a conveyor and an extension. The roller conveyor is only 16 mm thick so that it can fit in the 25 mm clearance between trays. It can extend in and out on either side if the tower carriage is almost its full length, which is slightly longer than a tray. The extension of the conveyor bed and the operation of the conveyor are controlled by two independent motors 86, so the tray can travel along the bed, while the bed is extending or not, depending on the use case. FIG. 8 shows the extractor fully retracted and fully extended.

In one embodiment, the dual mode extractor includes both independent drives and constrained drives that operate cooperatively and is adapted to retrieve and deliver objects having a flat bottom, or a substantially flat bottom.

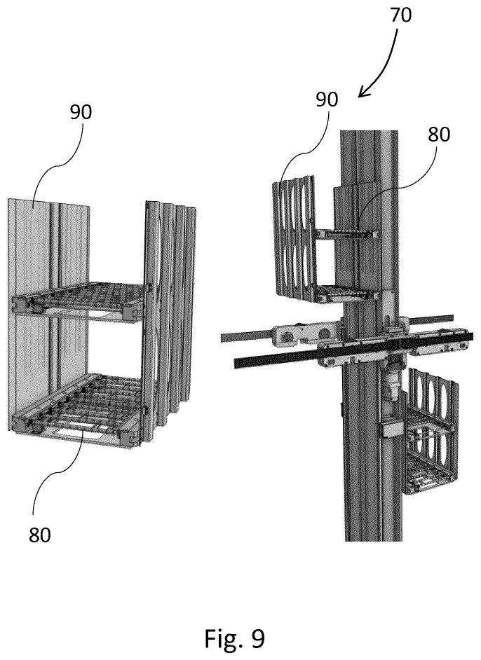

FIG. 9 shows extractors 80 mounted to the vertical carriages 90 of the tower 70.

### Interface to Transport Carts

Prior art systems are designed to deliver one item at a time to the operator or interfacing automation system. This fails to realize the potential of the tower to do more than just retrieve and store goods. If commanded, any of these systems could “shuffle” trays or objects so that they are arranged in a specific pattern or “sequence” on the shelves. But they can't do anything with this capability because the I/O port of the system only allows one load to exit/enter at a time.

The key insight of the ISSDs is that we take advantage of this capability. We replace a segment of shelving at one or both ends of the racking with an interface location for a cart with shelves. This “cache” cart is loaded up with a number of trays from anywhere in the aisle and delivered as a single batch to the next step in the operation, eliminating the need for downstream sorts and merges. In this way, the sequenced batch of items can be removed or inducted in a single transaction.

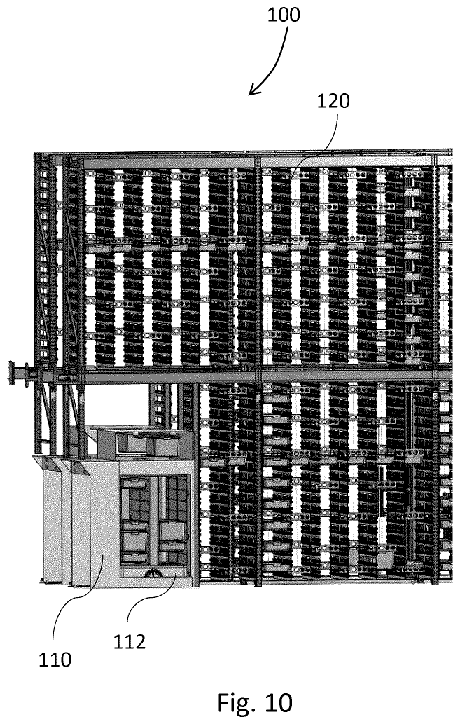

FIG. 10 illustrates the racking 100 with one section of shelving replaced with a cart interface 110 and shows the cart with a shelf arrangement matching the arrangement in the rack 120. In one embodiment, the main rack comprises a “fixed rack” and the cart as a “mobile rack.”

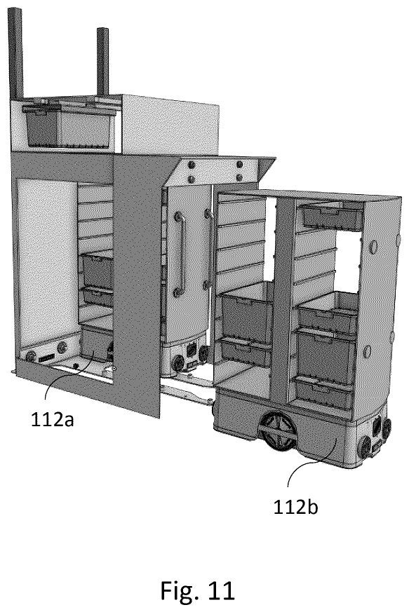

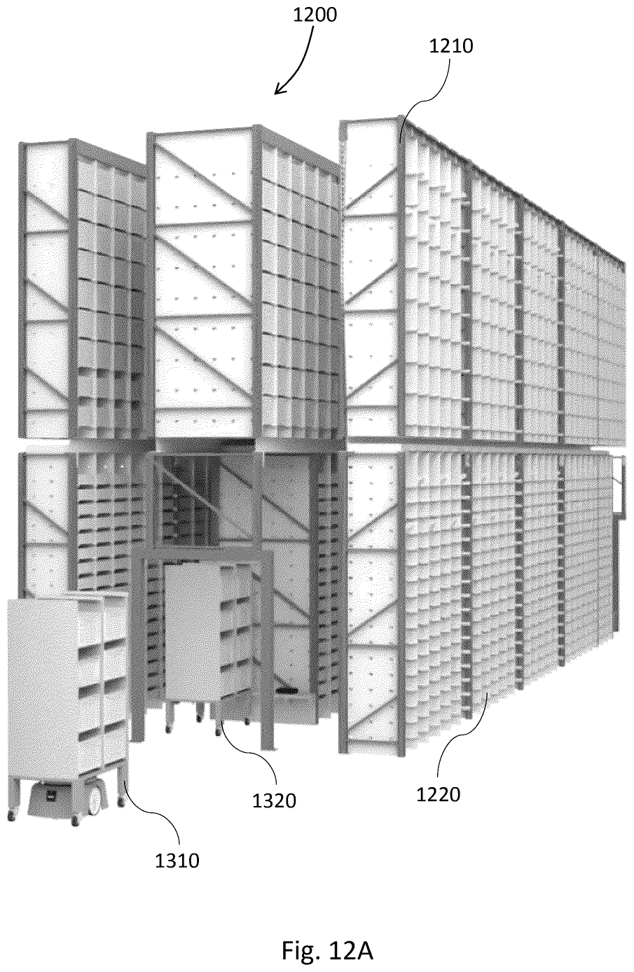

In operation, carts 112 are inserted (manually or using mobile robots) into the docking location at the end of the aisle. The cart side face is aligned with the pick face of the rack. The tower is able to load and unload the cart just as if they are standard shelf positions. The carts and ISSDs are coordinated by the control system so that the cart areas are only serviced by the tower when they are properly docked and interlocked. FIG. 11 shows the cart docks with carts 112a in position and with carts 112b approaching.

### Storage Solution Benefits

As described herein, the storage solution provides a number of benefits. In one embodiment, the system uses High Density, Single-Deep Racking with random access with no speed penalty. The storage uses High Performance Handling Tower using a light weight, quad handling, integrated to racking. The system provides a Low Latency Storage and Retrieval optimized aisle length to rack height. The system allows for High Throughput with multiple aisles and towers based on mix and storage capacity. The system includes Integrated Mobile Racks, in one embodiment. The towers used by the system, in one embodiment, provide for induction, retrieval, loading, unloading, sorting, and mixing, all with the same handling towers. No extra steps are needed. The system supports G2X solutions, such as Goods 2 Person, Goods 2 Line, Goods 2Robot, Goods 2 Shipping. The storage system provides compiled storage solutions. Transport loads are pre-kitted for: order building, lineside operations, milk runs, ship to store, and others.

In one embodiment, a storage tower with four manipulators stores and retrieves trays in the racking. Mobile Racks are outfitted to carry multiple trays. The carts are docked into the storage volume for loading and unloading by the tower. The carts are then transported to the next activity such as picking, packing, assembly, shipping, kitting, and other inventory management tasks.

### Sample System Inventory Processing

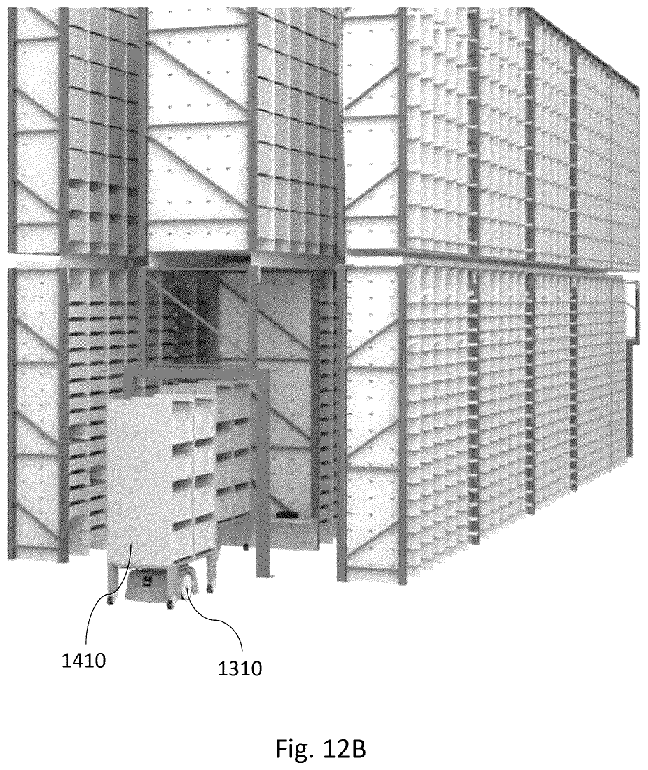

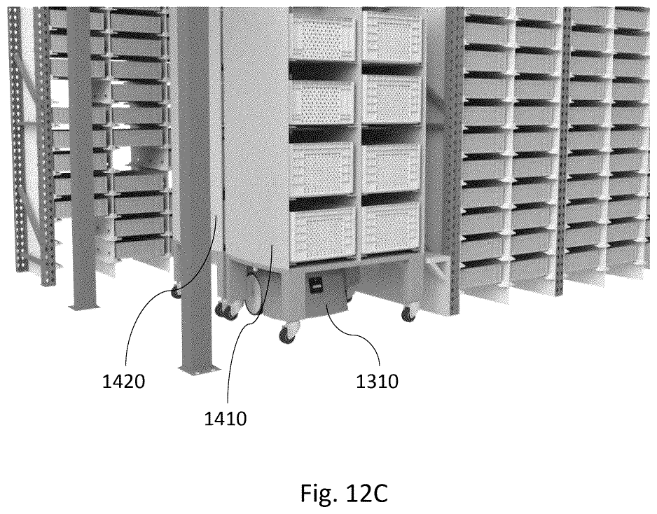

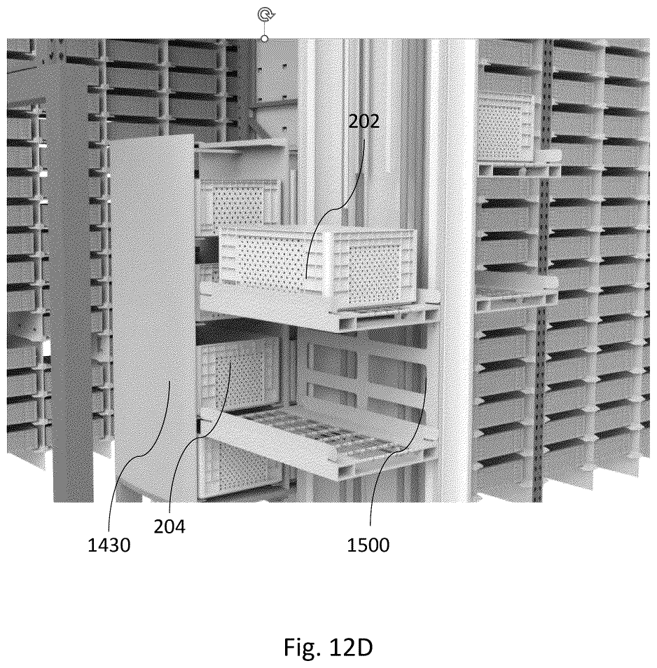

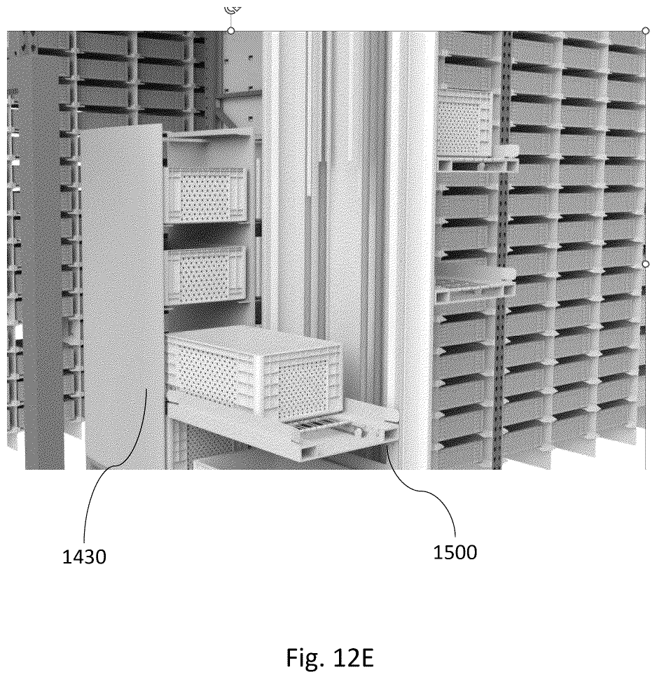

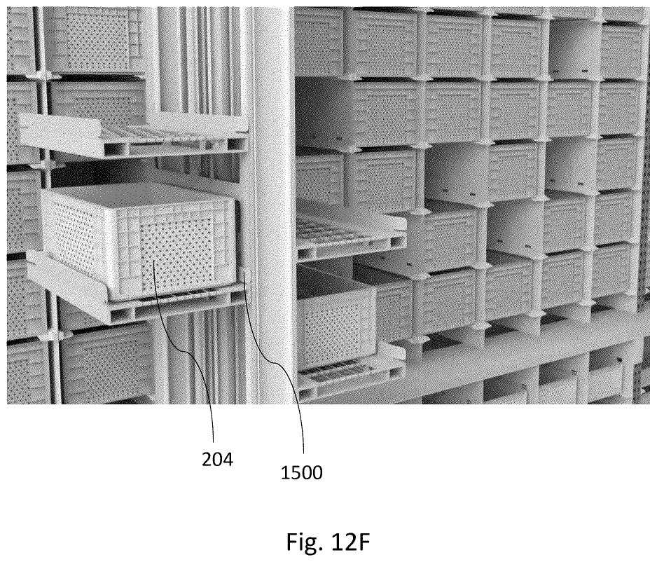

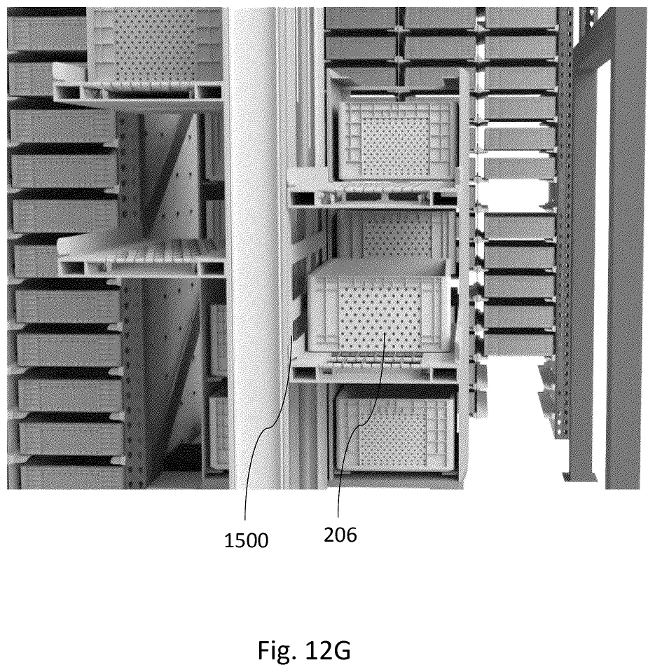

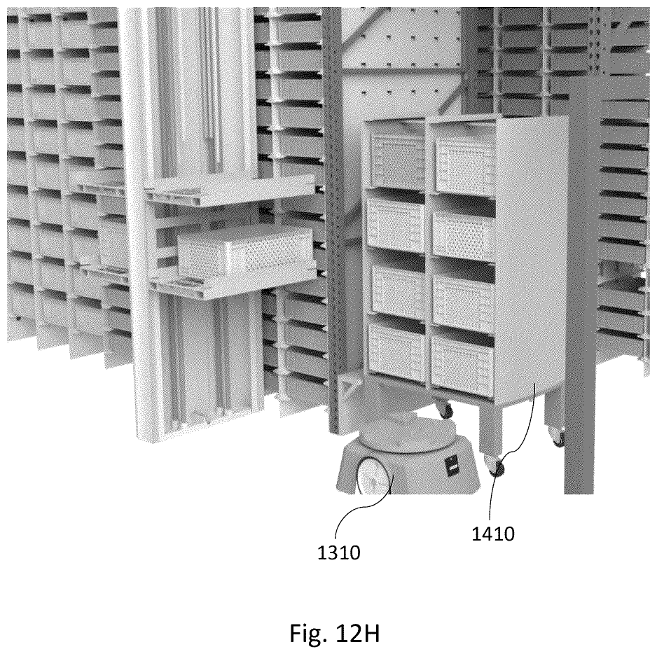

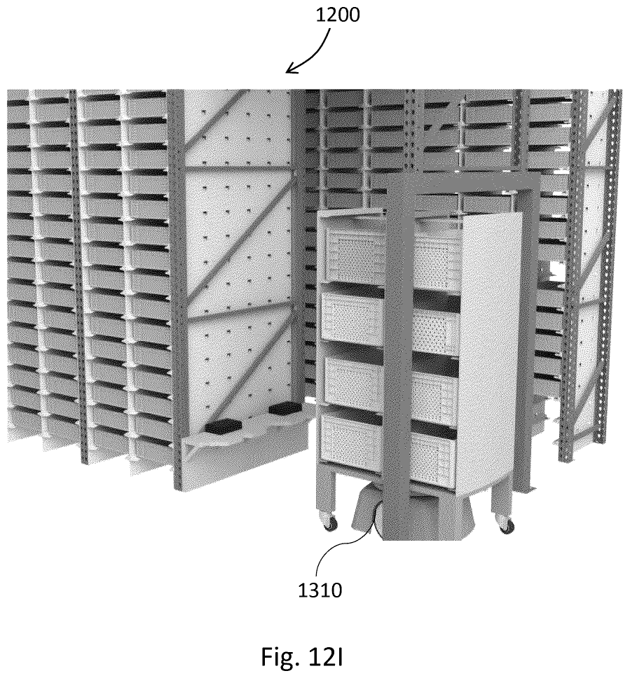

Depicted in FIGS. 12A-I are some sample inventory management steps undertaken by an embodiment of the system.

Shown in FIG. 12A is a side view of a rack 1200 with shelves 1210 and bins 1220. A mobile robot 1310 is moving a mobile cart with trays to the rack. A second mobile cart 1320 is already present in the rack.

FIG. 12B shows the mobile robot 1310 docking the mobile cart 1410 in the rack. FIG. 12C shows the mobile robot 1310 switching from the first mobile cart 1410 to the second mobile cart 1420. FIG. 12D shows the tower robot 1500 bringing a tray 202 to the mobile cart 1430 in the rack as well as extracting a tray 204 from the mobile cart, using the extractors described herein. FIG. 12E shows the interaction of the tower robot 1500 with the mobile cart 1430. FIG. 12F shows the tower robot 1500 departing the mobile cart and moving the tray 204 to its destination in the rack. FIG. 12G shows the tower robot 1500 returning to the mobile cart with a replacement tray 206. FIG. 12H shows the mobile robot 1310 returning to the mobile cart 1410. FIG. 12I shows the mobile robot 1310 departing the rack 1200 with the exchanged trays.

Although exemplary implementations of the invention have been depicted and described in detail herein, it will be apparent to those skilled in the relevant art that various modifications, additions, substitutions, and the like can be made without departing from the spirit of the invention. These are therefore considered to be within the scope of the invention as defined in the following claims.

It is to be understood that the above description is intended to be illustrative and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the invention parameters, they are by no means limiting but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

1. A material handling system comprising:
a movable cart configured to carry a plurality of trays;
an automated mobile robot configured to transport the movable cart; and
a docking interface configured to receive the movable cart and align the movable cart for loading or unloading operations.

2. The system of claim 1, wherein the movable cart is configured to dock at the docking interface under control of the automated mobile robot.

3. The system of claim 1, wherein the movable cart is configured to be manually positioned at the docking interface.

4. The system of claim 1, wherein the docking interface comprises mechanical alignment features configured to position the movable cart relative to a storage or processing system.

5. The system of claim 1, wherein the automated mobile robot is configured to undock the movable cart from the docking interface after completion of loading or unloading operations.

6. A material handling system comprising:
a plurality of trays each having a flange configured to support the tray;
a movable cart configured to carry the flange-supported trays;
an automated mobile robot configured to transport the movable cart; and
a docking interface configured to receive the movable cart for transfer of the flange-supported trays.

7. The system of claim 6, wherein the movable cart comprises shelves arranged to support the flange-supported trays at a predetermined pitch.

8. The system of claim 6, wherein the movable cart provides a vertical clearance between adjacent trays of less than 30 millimeters.

9. The system of claim 6, wherein the movable cart includes thin shelf risers configured to support the flange-supported trays with high storage density.

10. The system of claim 6, wherein the docking interface aligns the movable cart such that the shelves of the movable cart match corresponding tray positions of a storage or processing system.

11. A material handling system comprising:
a plurality of trays each having a flange configured to support the tray;
a stationary racking structure comprising shelf brackets configured to engage the tray flanges;
a movable cart configured to dock with the stationary racking structure;
an automated mobile robot configured to transport the movable cart; and
an automated storage and retrieval system configured to transfer the flange-supported trays between the stationary racking structure and the movable cart.

12. The system of claim 11, wherein the shelf brackets of the stationary racking structure are spaced at 150-millimeter intervals.

13. The system of claim 11, wherein trays of different heights are storable in any slot of the stationary racking structure.

14. The system of claim 11, wherein the stationary racking structure provides a vertical clearance between adjacent trays of less than 30 millimeters.

15. The system of claim 11, wherein the movable cart comprises shelves arranged to match the spacing of the shelf brackets of the stationary racking structure.

16. The system of claim 11, wherein the docking interface aligns the movable cart such that the movable cart shelves are accessible to the automated storage and retrieval system.

17. The system of claim 11, wherein the automated mobile robot is configured to dock and undock the movable cart from the stationary racking structure.
